(19) United States
(12) Patent Application Publication
(10) Pub. No.: US 2022/0374831 A1
(43) Pub. Date: Nov. 24, 2022

(54) DELIVERY PLAN GENERATION SYSTEM, DELIVERY PLAN GENERATION DEVICE, AND COMPUTER READABLE RECORDING MEDIUM

(71) Applicant: TOYOTA JIDOSHA KABUSHIKI KAISHA, Toyota-shi (JP)

(72) Inventors: Yu NAGATA, Tokyo (JP); Toshihiro NAKAMURA, Sunto-gun (JP)

(73) Assignee: TOYOTA JIDOSHA KABUSHIKI KAISHA, Toyota-shi (JP)

(21) Appl. No.: 17/687,833

(22) Filed: Mar. 7, 2022

(30) Foreign Application Priority Data
May 24, 2021 (JP) 2021-087257

(51) Int. Cl. G06Q 10/08; G01C 21/34

(52) U.S. Cl. CPC G06Q 10/0832; G01C 21/3469

(57) ABSTRACT

A delivery plan generation system includes a delivery plan generation device configured to generate a baggage delivery plan using a BEV and an engine vehicle. The delivery plan generation device includes a processor configured to: assign delivery of baggage having a load of equal to or more than a certain value to the engine vehicle; and assign delivery of baggage having a load of less than the certain value to the BEV.

The present application claims priority to and incorporates by reference the entire contents of Japanese Patent Application No. 2021-087257 filed in Japan on May 24, 2021.

### BACKGROUND

The present disclosure relates to a delivery plan generation system, a delivery plan generation device, and a computer readable recording medium.

JP 2020-91887 A discloses a delivery plan generation method for generating a delivery plan based on a delivery distance (delivery distance cost) to a delivery destination.

### SUMMARY

Recently, in a delivery company and a logistics company, it has been considered to replace a delivery vehicle from an engine vehicle (conventional vehicle) to a battery electric vehicle (BEV). When a BEV is used as a delivery vehicle, a delivery plan generated based on only a delivery distance may reduce delivery efficiency. Thus, when a BEV is used as a delivery vehicle, generating a delivery plan with high delivery efficiency is demanded.

There is a need for a delivery plan generation system, a delivery plan generation device, and a computer readable recording medium capable of generating a delivery plan with high delivery efficiency in a case where a BEV is used as a delivery vehicle.

According to one aspect of the present disclosure, there is provided a delivery plan generation system including a delivery plan generation device configured to generate a baggage delivery plan using a BEV and an engine vehicle, the delivery plan generation device including a processor configured to: assign delivery of baggage having a load of equal to or more than a certain value to the engine vehicle; and assign delivery of baggage having a load of less than the certain value to the BEV.

### BRIEF DESCRIPTION OF THE DRAWINGS

FIG. 1 is a schematic diagram illustrating the overall configuration of a delivery plan generation system according to an embodiment;

FIG. 2 is a block diagram illustrating details of each component of the delivery plan generation system according to the embodiment;

FIG. 3 is a flowchart illustrating a first example of a delivery plan generation method executed by the delivery plan generation system according to the embodiment; and

FIG. 4 is a flowchart illustrating a second example of a delivery plan generation method executed by the delivery plan generation system according to the embodiment.

### DETAILED DESCRIPTION

A delivery plan generation system, a delivery plan generation device, and a computer readable recording medium storing a delivery plan generation program according to an embodiment of the present disclosure will be described with reference to the drawings. Note that components in the embodiment below include those that may be easily replaced by those skilled in the art or those that are substantially the same.

### Delivery Plan Generation System

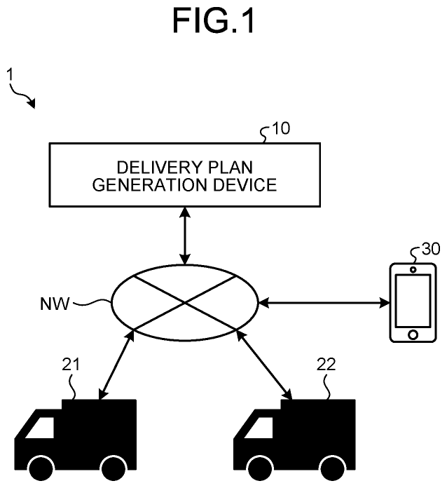

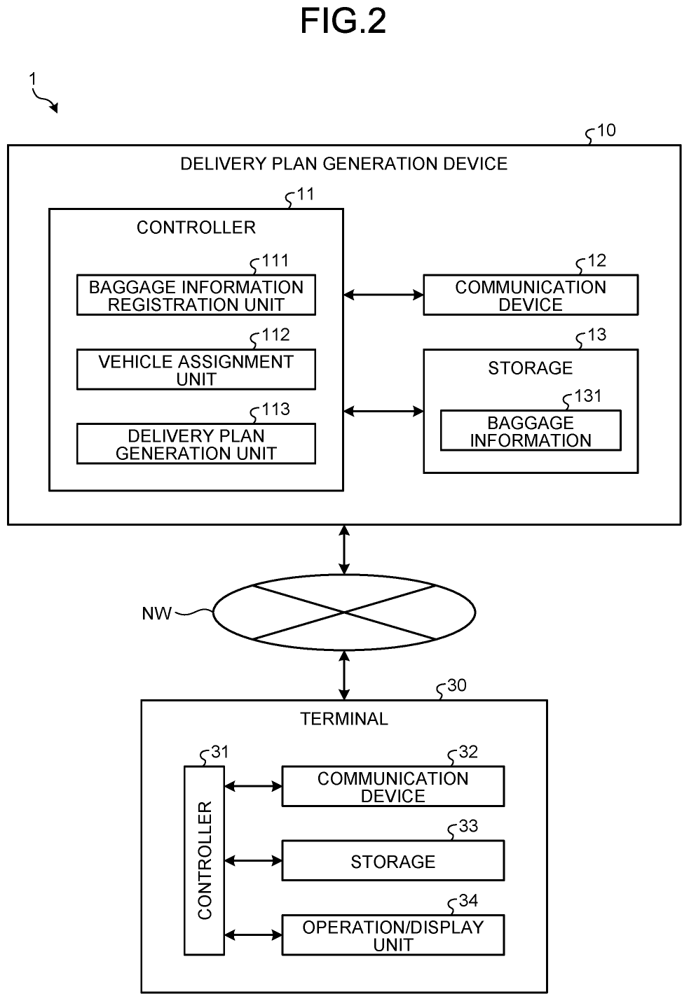

The delivery plan generation system according to the embodiment will be described with reference to FIGS. 1 and 2. As illustrated in FIG. 1, a delivery plan generation system 1 includes a delivery plan generation device 10, a BEV 21, an engine vehicle 22, and a terminal 30. The delivery plan generation device 10 and the terminal 30 have a communication function, and may communicate with each other over a network NW. The network NW includes, for example, an internet network and a mobile phone network.

The BEV 21 and the engine vehicle 22 are delivery vehicles for delivering baggage a user has requested for. The BEV 21 and the engine vehicle 22 are managed by, for example, a delivery company that delivers baggage. Furthermore, the BEV 21 and the engine vehicle 22 may have a communication function. When the BEV 21 and the engine vehicle 22 have a communication function, the BEV 21 and the engine vehicle 22 exchange various pieces of information with the delivery plan generation device 10 over the network NW.

### Delivery Plan Generation Device

The delivery plan generation device 10 generates a baggage delivery plan using the BEV 21 and the engine vehicle 22. The delivery plan generation device 10 is implemented by a general-purpose computer such as a workstation and a personal computer. Furthermore, the delivery plan generation device 10 is managed by, for example, a delivery company that delivers baggage.

As illustrated in FIG. 2, the delivery plan generation device 10 includes a controller 11, a communication device 12, and a storage 13. Specifically, the controller 11 includes a processor and a memory (main storage). The processor includes a central processing unit (CPU), a digital signal processor (DSP), a field-programmable gate array (FPGA), a graphics processing unit (GPU), and the like. The memory includes a random access memory (RAM), a read only memory (ROM), and the like.

The controller 11 loads a program stored in the storage 13 into a work area of the main storage, and executes the program. The controller 11 implements a function that matches a predetermined purpose by controlling each component and the like through the execution of the program. The controller 11 functions as a baggage information registration unit 111, a vehicle assignment unit 112, and a delivery plan generation unit 113 through the execution of a program stored in the storage 13.

The baggage information registration unit 111 registers information on baggage to be delivered (hereinafter, referred to as “baggage information”) in a predetermined region of the storage 13. The “baggage information” includes, for example, information on a delivery destination to deliver baggage (e.g., address of delivery destination, name, and telephone number), a designated delivery time for baggage, a load (weight) of baggage, a size of baggage, and a cooling type for baggage. The “designated delivery time for baggage” includes the presence or absence of delivery designation and a designated delivery time (when there is delivery designation). Furthermore, the “cooling type for baggage” refers to temperature at the time of delivering baggage, and is classified as, for example, normal temperature, cold storage, and freezer storage.

The baggage information registration unit 111 registers baggage information based on baggage delivery receipt in a delivery company. The baggage delivery receipt is performed online or offline. When the baggage delivery receipt is performed online, for example, a baggage delivery request is transmitted (output) from the terminal 30 possessed by a user to the delivery plan generation device 10. Accordingly, the baggage information registration unit 111 registers information included in the baggage delivery request in the storage 13 as baggage information 131.

In contrast, when the baggage delivery receipt is performed offline, for example, a baggage delivery slip filled in by the user is submitted to the delivery company. Then, a staff member of the delivery company inputs information included in the baggage delivery slip to the delivery plan generation device 10. Accordingly, the baggage information registration unit 111 registers information included in the baggage delivery slip in the storage 13 as baggage information 131.

The vehicle assignment unit 112 assigns a delivery vehicle that delivers baggage for each piece of baggage for which the baggage information 131 is registered by the baggage information registration unit 111. The vehicle assignment unit 112 determines by which one of the BEV 21 and the engine vehicle 22 the baggage is to be delivered in accordance with the load of the baggage.

Specifically, the vehicle assignment unit 112 assigns the delivery of baggage having a load of equal to or more than a certain value (e.g., 100 kg or more) to the engine vehicle 22, and assigns the delivery of baggage having a load less than the certain value (e.g., less than 100 kg) to the BEV 21. Here, while the BEV 21 has a large influence of the magnitude of a vehicle weight on electric economy, the engine vehicle 22 has a relatively small influence of the magnitude of a vehicle weight on fuel economy. Thus, decrease in the electric economy of the BEV 21 at the time of delivering baggage may be inhibited by assigning the delivery of baggage having a load of less than a certain value to the BEV 21. Note that, in the vehicle assignment unit 112, a reference load of baggage assigned to the BEV 21 and the engine vehicle 22 may be determined based on, for example, the performance (e.g., electric economy) of the BEV 21.

The delivery plan generation unit 113 generates a baggage delivery plan. The delivery plan generation unit 113 generates a delivery plan for baggage assigned to the engine vehicle 22 and a delivery plan for baggage assigned to the BEV 21 by different methods. Hereinafter, one example of a method of generating a delivery plan using the engine vehicle 22 and one example of a method of generating a delivery plan using the BEV 21 will be described.

### Delivery Plan Using Engine Vehicle (Delivery Time is Not Designated)

The delivery plan generation unit 113 determines a delivery route with a minimum total delivery distance (delivery distance cost) for delivering baggage assigned to the engine vehicle 22. For example, a case where the engine vehicle 22 delivers two pieces of baggage will be discussed. In this case, as described below, the delivery plan generation unit 113 rearranges the order of deliveries to delivery destinations set for pieces of baggage. The delivery plan generation unit 113 thereby searches for a candidate of a delivery route through which the engine vehicle 22 departs from a departure point (e.g., delivery company), goes through each delivery destination, and returns to the departure point again.

Delivery route candidate 1: departure point→delivery destination A→delivery destination B→departure point (total delivery distance: 15 km)

Delivery route candidate 2: departure point→delivery destination B→delivery destination A→departure point (total delivery distance: 12 km)

Then, the delivery plan generation unit 113 determines the delivery route candidate 2 having the minimum total delivery distance (=12 km) among the delivery route candidates 1 and 2, which have been searched for, as a delivery route of the engine vehicle 22. As described above, baggage may be delivered efficiently and promptly by generating a delivery plan including a delivery route having a minimum total delivery distance.

### Delivery Plan Using Engine Vehicle (Delivery Time is Designated)

When baggage to be delivered includes baggage for which a time for delivery to a delivery destination is designated, the delivery plan generation unit 113 may generate a delivery plan based on the designated delivery time with priority. For example, a case where the engine vehicle 22 delivers two pieces of baggage including baggage for which a delivery time has been designated as illustrated below will be discussed.

Time for Delivering Baggage to Delivery Destination A: Not Designated

Designated Time for Delivering Baggage to Delivery Destination B: 15:00 to 18:00

In this case, as described below, the delivery plan generation unit 113 rearranges the order of deliveries based on a designated delivery time. The delivery plan generation unit 113 thereby searches for a candidate of a delivery route through which the engine vehicle 22 departs from a departure point (e.g., delivery company), goes through each delivery destination, and returns to the departure point again.

Delivery route candidate 1: departure point→delivery destination A→delivery destination B→departure point (total delivery distance: 15 km)

Delivery route candidate 2: departure point→delivery destination B→delivery destination A→departure point (total delivery distance: 12 km)

Then, the delivery plan generation unit 113 determines the delivery route candidate 2 having the minimum total delivery distance (=12 km) among the delivery route candidates 1 and 2 as a delivery route of the engine vehicle 22. As described above, baggage may be delivered in a time desired by a user by generating a delivery plan including a delivery route in compliance with a delivery time designated for the baggage.

### Delivery Plan Using BEV (Delivery Time is Not Designated)

The delivery plan generation unit 113 determines a delivery route with a minimum total traveling energy for delivering baggage assigned to the BEV 21. In other words, the “total traveling energy” indicates energy (electric power) consumed when baggage is delivered. For example, a case where the BEV 21 delivers two pieces of baggage will be discussed. In this case, as described below, the delivery plan generation unit 113 rearranges the order of deliveries to delivery destinations set for pieces of baggage. The delivery plan generation unit 113 thereby searches for a candidate of a delivery route through which the engine vehicle 22 departs from a departure point (e.g., delivery company), goes through each delivery destination, and returns to the departure point again.

Delivery route candidate 1: departure point→delivery destination A→delivery destination B→departure point (total delivery distance: 15 km)

Delivery route candidate 2: departure point→delivery destination B→delivery destination A→departure point (total delivery distance: 12 km)

Subsequently, the delivery plan generation unit 113 calculates the total traveling energy for each candidate of the delivery route, which has been searched for, based on the distance of the delivery route and the battery consumption amount (average battery consumption amount) of the BEV 21 in accordance with the load of the baggage. Specifically, the delivery plan generation unit 113 calculates the total traveling energy by adding a value obtained by multiplying the distance between baggage delivery destinations by the battery consumption amount of the BEV 21 in accordance with the load of the baggage.

For example, the following case will be discussed. In the case, in the delivery route candidates 1 and 2, the load of each piece of baggage, the battery consumption amount in the case of delivery through each delivery route candidate, and the distance between delivery destinations are as follows. Note that those experimentally or empirically determined in advance may be used as the battery consumption amount in the case of delivery through each delivery route candidate.

Load of Baggage to Delivery Destination A: 100 kg

Load of Baggage to Delivery Destination B: 10 kg

Battery Consumption Amount of Delivery Route Candidate 1: 2%/km

Battery Consumption Amount of Delivery Route candidate 2: 3%/km

Distance of Departure Point→Delivery Destination A, Distance of Delivery Destination A→Delivery Destination B, and Distance of Delivery Destination B→Departure Point: 5 km Each

Distance of Departure Point→Delivery Destination B, Distance of Delivery Destination B→Delivery Destination A, and Distance of Delivery Destination A→Departure Point: 4 km Each

In this case, the delivery plan generation unit 113 calculates the total traveling energy of the delivery route candidates 1 and 2 as follows.

Total Traveling Energy of Delivery Route Candidate 1=5 km (Departure Point→Delivery Destination A)×2%/km+5 km (Delivery Destination A→Delivery Destination B)×2%/km +5 km (Delivery Destination B→Departure Point)×2%/km =30%

Total Traveling Energy of Delivery Route Candidate 2=4 km (Departure Point→Delivery Destination B)×3%/km+4 km (Delivery Destination B→Delivery Destination A)×3%/km+4 km (Delivery Destination A→Departure Point)×3%/km=36%

Then, the delivery plan generation unit 113 determines the delivery route candidate 1 having the minimum total traveling energy (=30%) among the delivery route candidates 1 and 2 as a delivery route of the BEV 21. As described above, baggage may be efficiently delivered without decreasing the electric economy of the BEV 21 by generating a delivery plan including a delivery route having a minimum total traveling energy.

Delivery Plan Using BEV (Delivery Time Is Designated)

When baggage to be delivered includes baggage for which a time for delivery to a delivery destination is designated, the delivery plan generation unit 113 may generate a delivery plan based on the designated delivery time with priority. For example, a case where the BEV 21 delivers two pieces of baggage including baggage for which a delivery time has been designated as illustrated below will be discussed.

Time for Delivering Baggage to Delivery Destination A: Not Designated

Designated Time for Delivering Baggage to Delivery Destination B: 15:00 to 18:00

In this case, as described below, the delivery plan generation unit 113 rearranges the order of deliveries based on a designated delivery time. The delivery plan generation unit 113 thereby searches for a candidate of a delivery route through which the engine vehicle 22 departs from a departure point (e.g., delivery company), goes through each delivery destination, and returns to the departure point again.

Delivery route candidate 1: departure point→delivery destination A→delivery destination B→departure point (total delivery distance: 15 km)

Delivery route candidate 2: departure point→delivery destination B→delivery destination A→departure point (total delivery distance: 12 km)

Subsequently, the delivery plan generation unit 113 calculates the total traveling energy for each candidate of the delivery route, which has been searched for, based on the distance of the delivery route and the battery consumption amount (average battery consumption amount) of the BEV 21 in accordance with the load of the baggage. Specifically, the delivery plan generation unit 113 calculates the total traveling energy by adding a value obtained by multiplying the distance between baggage delivery destinations by the battery consumption amount of the BEV in accordance with the load of the baggage.

For example, the following case will be discussed. In the case, in the delivery route candidates 1 and 2, the load of each piece of baggage, the battery consumption amount in the case of delivery through each delivery route candidate, and the distance between delivery destinations are as follows. Those experimentally or empirically determined in advance may be used as the battery consumption amount in the case of delivery through each delivery route candidate.

Load of Baggage to Delivery Destination A: 100 kg Load of Baggage to Delivery Destination B: 10 kg Battery Consumption Amount of Delivery Route Candidate 1: 2%/km

Battery Consumption Amount of Delivery Route candidate 2: 3%/km

Distance of Departure Point→Delivery Destination A, Distance of Delivery Destination A→Delivery Destination B, and Distance of Delivery Destination B→Departure Point: 5 km Each

Distance of Departure Point→Delivery Destination B, Distance of Delivery Destination B→Delivery Destination A, and Distance of Delivery Destination A→Departure Point: 4 km Each

In this case, the delivery plan generation unit 113 calculates the total traveling energy of the delivery route candidates 1 and 2 as follows.

Total Traveling Energy of Delivery Route Candidate 1=5 km (Departure Point→Delivery Destination A)×2%/km+5 km (Delivery Destination A→Delivery Destination B)×2%/km +5 km (Delivery Destination B→Departure Point)33 2%/km =30%

Total Traveling Energy of Delivery Route Candidate 2=4 km (Departure Point→Delivery Destination B ×3%/km+4 km (Delivery Destination B→Delivery Destination A)×3%/km +4 km (Delivery Destination A→Departure Point)×3%/km=36%

Then, the delivery plan generation unit 113 determines the delivery route candidate 1 having the minimum total traveling energy (=30%) among the delivery route candidates 1 and 2 as a delivery route of the BEV 21. As described above, baggage may be delivered in a time desired by a user by generating a delivery plan including a delivery route in compliance with a delivery time designated for the baggage. Furthermore, baggage may be efficiently delivered without decreasing the electric economy of the BEV 21 by generating a delivery plan including a delivery route having a minimum total traveling energy.

### Delivery Plan Using BEV (Designated Delivery Time Is Changed)

When baggage for which a time for delivery to a delivery destination has been designated is included, the delivery plan generation unit 113 may inquire of a user, who has requested baggage for which a delivery time has been designated, whether or not the designated delivery time may be changed. For example, a case where the BEV 21 delivers two pieces of baggage including baggage for which a delivery time has been designated as illustrated below will be discussed.

Designated Time for Delivering Baggage to Delivery Destination A: 15:00 to 18:00

Designated Time for Delivering Baggage to Delivery Destination B: 12:00 to 15:00

In this case, as described below, the delivery plan generation unit 113 searches for a candidate of the delivery route in which the delivery order is rearranged based on the designated delivery time and a candidate of the delivery route in which the delivery order is rearranged without considering the designated delivery time.

Delivery route candidate 1 (based on designated delivery time): departure point→delivery destination B→delivery destination A→departure point (total delivery distance: 12 km)

Delivery route candidate 2 (without consideration of designated delivery time): departure point→delivery destination A→delivery destination B→departure point (total delivery distance: 15 km)

Subsequently, the delivery plan generation unit 113 calculates the total traveling energy for each candidate of the delivery route, which has been searched for, based on the distance of the delivery route and the battery consumption amount (average battery consumption amount) of the BEV 21 in accordance with the load of the baggage. Specifically, the delivery plan generation unit 113 calculates the total traveling energy by adding a value obtained by multiplying the distance between baggage delivery destinations by the battery consumption amount of the BEV 21 in accordance with the load of the baggage.

For example, the following case will be discussed. In the case, in the delivery route candidates 1 and 2, the load of each piece of baggage, the battery consumption amount in the case of delivery through each delivery route candidate, and the distance between delivery destinations are as follows. Those experimentally or empirically determined in advance may be used as the battery consumption amount in the case of delivery through each delivery route candidate.

Load of Baggage to Delivery Destination A: 100 kg Load of Baggage to Delivery Destination B: 10 kg Battery Consumption Amount of Delivery Route candidate 1: 3%/km

Battery Consumption Amount of Delivery Route candidate 2: 2%/km

Distance of Departure Point→Delivery Destination B, Distance of Delivery Destination B→Delivery Destination A, and Distance of Delivery Destination A→Departure Point: 4 km Each

Distance of Departure Point→Delivery Destination A, Distance of Delivery Destination A→Delivery Destination B, and Distance of Delivery Destination B→Departure Point: 5 km Each

In this case, the delivery plan generation unit 113 calculates the total traveling energy of the delivery route candidates 1 and 2 as follows.

Total Traveling Energy of Delivery Route Candidate 1=4 km (Departure Point→Delivery Destination B)×3%/km+4 km (Delivery Destination B→Delivery Destination A)×3%/km+4 km (Delivery Destination A→Departure Point)×3%/km=36%

Total Traveling Energy of Delivery Route Candidate 2=5 Km (Departure Point→Delivery Destination A)×2%/Km+5 Km (Delivery Destination A→Delivery Destination B)×2%/Km+5 Km (Delivery Destination B→Departure Point)×2%/Km=30%

In the delivery route candidates 1 and 2, the delivery route candidate 2 has the minimum total traveling energy. The delivery route candidate 2 is searched for without considering the designated delivery time. As described above, when the delivery order of the delivery route candidate having the minimum total traveling energy is not set based on the designated delivery time, the delivery plan generation unit 113 transmits information on whether or not the designated delivery time may be changed to the terminal 30 of a user who has requested the delivery of baggage for which a delivery time has been designated. Then, when acquiring information on the acceptance of change of the designated delivery time from the terminal 30, the delivery plan generation unit 113 determines the delivery route candidate 2 as a delivery route of the BEV 21.

In contrast, when not acquiring the information on the acceptance of change of the designated delivery time from the terminal 30, the delivery plan generation unit 113 determines the delivery route candidate 1 based on the designated delivery time as a delivery route of the BEV 21. Note that, when the delivery order of the delivery route candidate having the minimum total traveling energy is set based on the designated delivery time, the delivery plan generation unit 113 determines the delivery route candidate as a delivery route of the BEV 21. As described above, baggage may be efficiently delivered without decreasing the electric economy of the BEV 21 by generating a delivery plan including a delivery route having a minimum total traveling energy while inquiring of a user whether or not the designated delivery time may be changed, as necessary.

Note that, when the BEV 21 and the engine vehicle 22 have a communication function, the delivery plan generation unit 113 may transmit a delivery plan including a determined delivery route to the BEV 21 and the engine vehicle 22 over, for example, the network NW. Accordingly, the BEV 21 and the engine vehicle 22 may present the input delivery route to a driver by displaying the input delivery route on a screen of a car navigation system or the like.

The communication device 12 includes, for example, a local area network (LAN) interface board and a wireless communication circuit for wireless communication. The communication device 12 is connected to the network NW such as the Internet, which is a public communication network. Then, the communication device 12 is connected to the network NW to communicate with the terminal 30.

The storage 13 includes a recording medium such as an erasable programmable ROM (EPROM), a hard disk drive (HDD), and a removable medium. Examples of the removable medium include disc recording media such as a universal serial bus (USB) memory, a compact disc (CD), a digital versatile disc (DVD), and a Blu-ray (registered trademark) disc (BD). The storage 13 may store an operating system (OS), various programs, various tables, various databases, and the like.

The storage 13 stores the baggage information 131. The baggage information 131 includes, for example, information on a delivery destination to deliver baggage (e.g., address of delivery destination, name, and telephone number), a designated delivery time for baggage (e.g., presence or absence of delivery designation and designated delivery time (when there is delivery designation)), a load (weight) of baggage, a size of baggage, and a cooling type (classification of normal temperature, cold storage, freezer storage, and the like) for baggage.

### Terminal

The terminal 30 exchange various pieces of information with the delivery plan generation device 10 as necessary. The terminal 30 is implemented by, for example, a smartphone, a mobile phone, a tablet terminal, and a wearable computer owned by a user.

As illustrated in FIG. 2, the terminal 30 includes a controller 31, a communication device 32, a storage 33, and an operation/display unit 34. The controller 31, the communication device 32, and the storage 33 are similar to the controller 11, the communication device 12, and the storage 13 as hardware.

The communication device 32 communicates with the delivery plan generation device 10 by wireless communication via the network NW. The storage 33 stores, for example, a history of inquiry about whether or not a designated delivery time may be changed, which has been input from the delivery plan generation device 10, and an application software for requesting delivery of baggage, as necessary.

The operation/display unit 34 includes, for example, a touch panel display. The operation/display unit 34 has an input function and a display function. The input function is used for receiving an operation with, for example, a finger of a user or a pen. The display function is used for displaying various pieces of information under the control of the controller 31. The operation/display unit 34 displays, for example, a screen of the inquiry about whether or not a designated delivery time may be changed, which has been input from the delivery plan generation device 10, under the control of the controller 31.

### Delivery Plan Generation Method (First Example)

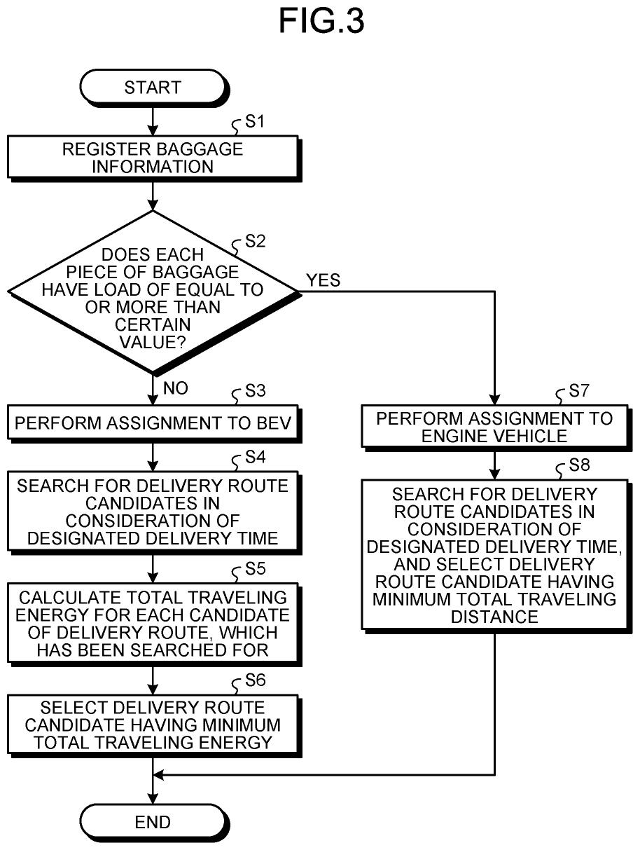

A first example of processing procedures of a delivery plan generation method executed by the delivery plan generation system 1 according to the embodiment will be described with reference to FIG. 3. In the example, processing mainly performed by the delivery plan generation device 10 will be described. Furthermore, in the example, a case will be described. In the case, baggage is assigned to the BEV 21 or the engine vehicle 22 based on the load of the baggage, and a delivery route for the baggage assigned to the BEV 21 is determined in compliance with a designated delivery time.

First, the baggage information registration unit 111 registers the baggage information 131 in the storage 13 (Step S1). Subsequently, the vehicle assignment unit 112 determines whether or not each piece of baggage for which the baggage information 131 has been registered has a load of equal to or more than a certain value (Step S2).

In Step S2, when determining that each piece of baggage does not have a load of equal to or more than a certain value (has a load of less than certain value) (No in Step S2), the vehicle assignment unit 112 assigns each piece of baggage to the BEV 21 (Step S3). Subsequently, the delivery plan generation unit 113 searches for delivery route candidates based on a designated delivery time (Step S4).

Subsequently, the delivery plan generation unit 113 calculates the total traveling energy for each candidate of the delivery route, which has been searched for, based on the distance of the delivery route and the battery consumption amount (average battery consumption amount) of the BEV 21 in accordance with the load of the baggage (Step S5). Subsequently, the delivery plan generation unit 113 selects a delivery route candidate having the minimum total traveling energy among the delivery route candidates, which have been searched for, as a delivery route of the BEV 21 (Step S6). Thus, the processing of generating a delivery plan of the BEV 21 is completed.

Here, in Step S2, when determining that each piece of baggage has a load of equal to or more than a certain value (Yes in Step S2), the vehicle assignment unit 112 assigns each piece of baggage to the engine vehicle 22 (Step S7). Subsequently, the delivery plan generation unit 113 searches for delivery route candidates based on the designated delivery time, and selects a delivery route candidate having the minimum total delivery distance among the delivery route candidates, which have been searched for, as a delivery route of the engine vehicle 22 (Step S8). Thus, the processing of generating a delivery plan of the engine vehicle 22 is completed.

### Delivery Plan Generation Method (Second Example)

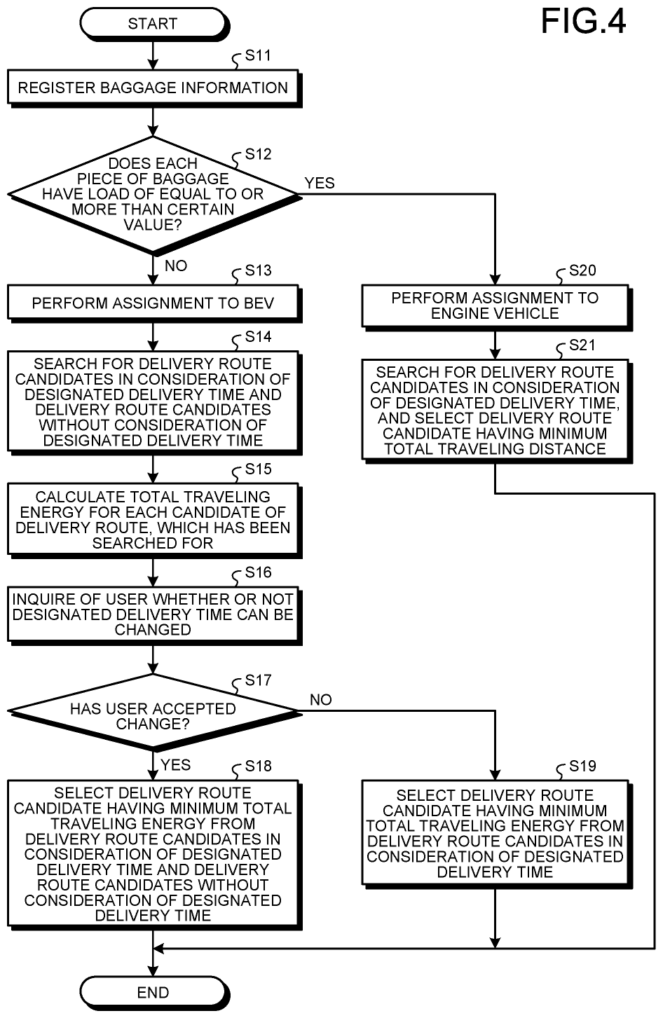

A second example of processing procedures of a delivery plan generation method executed by the delivery plan generation system 1 according to the embodiment will be described with reference to FIG. 4. In the example, processing mainly performed by the delivery plan generation device 10 will be described. Furthermore, in the example, a case will be described. In the case, baggage is assigned to the BEV 21 or the engine vehicle 22 based on the load of the baggage, and a delivery route for the baggage assigned to the BEV 21 is determined while a user is inquired of whether or not the designated delivery time may be changed.

First, the baggage information registration unit 111 registers the baggage information 131 in the storage 13 (Step S11). Subsequently, the vehicle assignment unit 112 determines whether or not each piece of baggage for which the baggage information 131 has been registered has a load of equal to or more than a certain value (Step S12).

In Step S2, when determining that each piece of baggage does not have a load of equal to or more than a certain value (has a load of less than certain value) (No in Step S12), the vehicle assignment unit 112 assigns each piece of baggage to the BEV 21 (Step S13). Subsequently, the delivery plan generation unit 113 searches for delivery route candidates based on the designated delivery time and delivery route candidates without consideration of the designated delivery time (Step S14).

Subsequently, the delivery plan generation unit 113 calculates the total traveling energy for each candidate of the delivery route, which has been searched for, based on the distance of the delivery route and the battery consumption amount (average battery consumption amount) of the BEV 21 in accordance with the load of the baggage (Step S15). Subsequently, when the delivery order of the delivery route candidate having the minimum total traveling energy is not set based on the designated delivery time, the delivery plan generation unit 113 transmits information on whether or not the designated delivery time may be changed to the terminal 30 of a user who has requested the delivery of baggage for which a delivery time has been designated, and performs inquiry (Step S16).

Subsequently, the delivery plan generation unit 113 determines whether or not the user has accepted the change of the designated delivery time (Step S17). In Step S17, when information on the acceptance of change of the designated delivery time is acquired from the terminal 30 of the user, an affirmative determination is made, and when the information is not acquired, a negative determination is made.

When it is determined in Step S17 that the user has accepted the change of the designated delivery time (Yes in Step S17), a candidate of the delivery route having the minimum total traveling energy is selected as a delivery route of the BEV 21 from the delivery route candidates based on the designated delivery time and the delivery route candidates without consideration of the designated delivery time (Step S18). In contrast, when it is determined in Step S17 that the user has not accepted the change of the designated delivery time (No in Step S17), a candidate of the delivery route having the minimum total traveling energy is selected as a delivery route of the BEV 21 from the delivery route candidates based on the designated delivery time (Step S19). Thus, the processing of generating a delivery plan of the BEV 21 is completed.

Here, in Step S12, when determining that each piece of baggage has a load of equal to or more than a certain value (Yes in Step S12), the vehicle assignment unit 112 assigns each piece of baggage to the engine vehicle 22 (Step S20). Subsequently, the delivery plan generation unit 113 searches for delivery route candidates based on the designated delivery time, and selects a delivery route candidate having the minimum total delivery distance among the delivery route candidates, which have been searched for, as a delivery route of the engine vehicle 22 (Step S21). Thus, the processing of generating a delivery plan of the engine vehicle 22 is completed.

As described above, in the delivery plan generation system, the delivery plan generation device, and the delivery plan generation program according to the embodiment, a delivery plan in which the BEV 21 delivers baggage having a light load is generated by assigning the delivery of baggage having a load of equal to or more than a certain value to the engine vehicle 22 and assigning the delivery of baggage having a load of less than the certain value to the BEV 21.

As described above, a decrease in the electric economy of the BEV 21 may be inhibited and overall delivery efficiency (operating rate) may be improved by causing the engine vehicle 22 to deliver baggage having a load of equal to or more than a certain value and causing the BEV 21 to deliver baggage having a load of less than the certain value. Therefore, when a BEV is used as a delivery vehicle, a delivery plan with high delivery efficiency may be generated.

Furthermore, according to the delivery plan generation system, the delivery plan generation device, and the delivery plan generation program of the embodiment, it is possible to enjoy advantages such as a reduction in fuel cost, a reduction in driving fatigue, a reduction in noise, and a reduction in environmental influence by using the BEV 21 as a delivery vehicle.

According to the present disclosure, when a BEV is used as a delivery vehicle, a delivery plan with high delivery efficiency may be generated.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A delivery plan generation system comprising
a delivery plan generation device configured to generate a baggage delivery plan using a BEV and an engine vehicle, the delivery plan generation device comprising a processor configured to:
assign delivery of baggage having a load of equal to or more than a certain value to the engine vehicle; and
assign delivery of baggage having a load of less than the certain value to the BEV.

2. The delivery plan generation system according to claim 1, wherein the processor is configure to:
search for candidates of a delivery route by rearranging an order of deliveries to delivery destinations set for each piece of baggage, when delivery of the baggage is assigned to the BEV;
calculate total traveling energy for each of the searched candidates of the delivery route based on a distance of the delivery route and a battery consumption amount of the BEV in accordance with the load of the baggage; and
determine a delivery route having a minimum total traveling energy among the candidates of the delivery route as a delivery route of the BEV.

3. The delivery plan generation system according to claim 2, wherein the processor is configured to search for the candidates of the delivery route by rearranging the delivery order based on a designated delivery time when baggage for which a time for delivery to the delivery destination is designated is included.

4. The delivery plan generation system according to claim 2, wherein the processor is configured to:
search for the candidates of the delivery route in which the delivery order is rearranged based on the designated delivery time and the candidates of the delivery route in which the delivery order is rearranged without considering the designated delivery time when baggage for which a time for delivery to the delivery destination is designated is included;
calculate total traveling energy for each of the searched candidates of the delivery route based on a distance of the delivery route and a battery consumption amount of the BEV in accordance with the load of the baggage;
determine, when the delivery order of a delivery route having a minimum total traveling energy is set based on the designated delivery time, the delivery route as a delivery route of the BEV; and
output, when the delivery order of the delivery route having a minimum total traveling energy is not set based on the designated delivery time, information on whether or not the designated delivery time is allowed to be changed to a terminal of a user who has requested delivery of baggage for which the delivery time has been designated, and determine, when acquiring information on acceptance of change of the designated delivery time from the terminal, the delivery route as a delivery route of the BEV.

5. The delivery plan generation system according to claim 2, wherein the processor is configured to calculate the total traveling energy by adding a value obtained by multiplying a distance between baggage delivery destinations by a battery consumption amount of the BEV in accordance with the load of the baggage.

6. A delivery plan generation device configured to generate a baggage delivery plan using a BEV and an engine vehicle, the delivery plan generation device comprising
a processor configured to:
assign delivery of baggage having a load of equal to or more than a certain value to the engine vehicle; and
assign delivery of baggage having a load of less than the certain value to the BEV.

7. The delivery plan generation device according to claim 6, wherein the processor is configure to:
search for candidates of a delivery route by rearranging an order of deliveries to delivery destinations set for each piece of baggage, when delivery of the baggage is assigned to the BEV;
calculate total traveling energy for each of the searched candidates of the delivery route based on a distance of the delivery route and a battery consumption amount of the BEV in accordance with the load of the baggage; and
determine a delivery route having a minimum total traveling energy among the candidates of the delivery route as a delivery route of the BEV.

8. The delivery plan generation device according to claim 7, wherein the processor is configured to search for the candidates of the delivery route by rearranging the delivery order based on a designated delivery time when baggage for which a time for delivery to the delivery destination is designated is included.

9. The delivery plan generation device according to claim 7, wherein the processor is configured to:
search for the candidates of the delivery route in which the delivery order is rearranged based on the designated delivery time and the candidates of the delivery route in which the delivery order is rearranged without considering the designated delivery time when baggage for which a time for delivery to the delivery destination is designated is included;
calculate total traveling energy for each of the searched candidates of the delivery route based on a distance of the delivery route and a battery consumption amount of the BEV in accordance with the load of the baggage;
determine, when the delivery order of a delivery route having a minimum total traveling energy is set based on the designated delivery time, the delivery route as a delivery route of the BEV; and
output, when the delivery order of the delivery route having a minimum total traveling energy is not set based on the designated delivery time, information on whether or not the designated delivery time is allowed to be changed to a terminal of a user who has requested delivery of baggage for which the delivery time has been designated, and determine, when acquiring information on acceptance of change of the designated delivery time from the terminal, the delivery route as a delivery route of the BEV.

10. The delivery plan generation device according to claim 7, wherein the processor is configured to calculate the total traveling energy by adding a value obtained by multiplying a distance between baggage delivery destinations by a battery consumption amount of the BEV in accordance with the load of the baggage.

11. A non-transitory computer-readable recording medium on which a program for generating a baggage delivery plan using a BEV and an engine vehicle is recorded, the program instructing a processor to execute:
assigning delivery of baggage having a load of equal to or more than a certain value to the engine vehicle; and
assigning delivery of baggage having a load of less than the certain value to the BEV.

12. The non-transitory computer-readable recording medium according to claim 11, wherein the program instructs the processor to execute:
searching for candidates of a delivery route by rearranging an order of deliveries to delivery destinations set for each piece of baggage, when delivery of the baggage is assigned to the BEV;
calculating total traveling energy for each of the searched candidates of the delivery route based on a distance of the delivery route and a battery consumption amount of the BEV in accordance with the load of the baggage; and
determining a delivery route having a minimum total traveling energy among the candidates of the delivery route as a delivery route of the BEV.

13. The non-transitory computer-readable recording medium according to claim 12, wherein the program instructs the processor to execute searching for the candidates of the delivery route by rearranging the delivery order based on a designated delivery time when baggage for which a time for delivery to the delivery destination is designated is included.

14. The non-transitory computer-readable recording medium according to claim 12, wherein the program instructs the processor to execute:
searching for the candidates of the delivery route in which the delivery order is rearranged based on the designated delivery time and the candidates of the delivery route in which the delivery order is rearranged without considering the designated delivery time when baggage for which a time for delivery to the delivery destination is designated is included;
calculating total traveling energy for each of the searched candidates of the delivery route based on a distance of the delivery route and a battery consumption amount of the BEV in accordance with the load of the baggage;
determining, when the delivery order of a delivery route having a minimum total traveling energy is set based on the designated delivery time, the delivery route as a delivery route of the BEV; and
outputting, when the delivery order of the delivery route having a minimum total traveling energy is not set based on the designated delivery time, information on whether or not the designated delivery time is allowed to be changed to a terminal of a user who has requested delivery of baggage for which the delivery time has been designated, and determining, when acquiring information on acceptance of change of the designated delivery time from the terminal, the delivery route as a delivery route of the BEV.

15. The non-transitory computer-readable recording medium according to claim 12, wherein the program instructs the processor to execute calculating the total traveling energy by adding a value obtained by multiplying a distance between baggage delivery destinations by a battery consumption amount of the BEV in accordance with the load of the baggage.
